(19) United States
(12) Patent Application Publication
(10) Pub. No.: US 2006/0095752 A1
(43) Pub. Date: May 4, 2006

(54) [METHOD FOR RETURN INSTRUCTION IDENTIFICATION AND ASSOCIATED METHOD FOR RETURN TARGET POINTER PREDICTION]

(76) Inventor: Min-Cheng Kao, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/711,159

(22) Filed: Aug. 28, 2004

(51) Int. Cl. G06F 9/00

(52) U.S. Cl. 712/242; 712/239

(57) ABSTRACT

A method and device for return instruction prediction in microprocessors and digital signal processors. The method and device uses a return target buffer, in which a return instruction address table serves to store addresses of return instructions, and a return target stack is used to store target pointers of return instructions, thereby correct prediction results can be provided in the fetch stage of a pipeline.

### BACKGROUND OF INVENTION

1. Field of the Invention

This invention relates to a method for predicting branch instruction, and more particularly to a method for predicting target pointer of return instruction in a microprocessor and a digital signal processor.

2. Description of Related Art

A microprocessor and a digital signal processor for present day both utilize multi-stage pipeline system for processing instructions. A pipeline comprises stages of fetch, decode, and execute, etc. In order to improve processing efficiency, usually multiple stages of the pipeline are operated simultaneously, e.g. when the third stage processes the first instruction, the second stage processes the second instruction, and the first stage processes the third instruction, instead of the second instruction not being processed until the first instruction is done with the pipeline, while most stages are idling and wasting resources.

Such a pipeline system works smoothly when instructions are given sequentially, yet when branch instruction is given, a problem occurs. As a branch instruction is give, the program counter jumps out, such that the results obtained from the previous stages in the pipeline are flushed such as to deal with target pointer instruction of the branch instruction. That is, the process time for previous stages is wasted.

A technology for predicting target pointer of branch instruction is developed, also known as “branch prediction”. The purpose of branch prediction is to predict a target pointer during fetch or decode stage of the pipeline, such that the pipeline is able to process the subsequent instructions. In a later stage, if the target pointer is predicted correctly, the results obtained from previous stages are not wasted, and efficiency of each stage is retained.

Branch instructions are divided into categories, such as direct, indirect, relative, absolute, conditional, and unconditional, etc. Call instructions for calling subroutine and corresponding return instructions are also belonged to branch instructions.

Branch prediction possesses a variety. A traditional branch target buffer is not able to process a more complicated call for subroutine. Referring to FIG. 1, an infinite loop of a program section is demonstrated. Providing the length of the call instruction is four bytes, the program section is performed from the address 1100, and the code 1100 calls for the subroutine “print” located at 1500, and when proceeding to the address 1600 performing “return”, the branch target buffer would record additionally, and corresponding the return instruction address 1600 to the return target pointer 17104. Then, the address 1200 calls for subroutine “print” located at 1500, and when proceeding to return instruction at 1600, the branch target buffer predicts the next address being at 1104, yet the actual return target pointer is 1204, indicating a prediction error. The branch target buffer updates the return instruction address 1600 corresponding to the return target pointer to be 1204, and then when next time the address 1100 calls “print” for return, the buffer predicts the return target pointer to be 1204, and is still erroneous. When multiple addresses share a common subroutine, it leads to continuous erroneous prediction when applying traditional branch target buffer. U.S. Pat. No. 6,601,161 provides a method, comprising foregoing branch target buffer, which makes prediction in fetch stage in a pipeline, but under a slightly complicated process does not work accurately.

U.S. Pat. No. 6,425,076 further provides another method, providing a plurality of predicting methods, respectively determines reliability and priority, and screening a predicting results from a group. The drawback to the method is not able to predict until decoding stage of the pipeline, which is delayed, especially when multiple fetching stages are included in the pipeline.

U.S. Pat. No. 6,609,194 further provides a method, comprising another method for predicting various types of branch instruction, one among which is call/return stack for predicting target pointer of the return instruction. This method also possesses the drawback of delayed prediction, which is per formed at decode stage of the pipeline.

According to the above descriptions and examples, a method and structure for previously predicting return instruction at fetch stage in a pipeline is desired.

### SUMMARY OF INVENTION

The present invention is directed to a method for predicting a target pointer of a return instruction, which provides a correct predicting result at fetch stage of a pipeline, and being able to process a complicated program steps.

The present invention is directed to a method for identifying return instruction, comprising providing a return target stack at initial, and fetching a current instruction; if the current instrtemptempuction is a call instruction, adding the address of the current instruction with a length of the current instruction to obtain a target pointer to be stored to the return target stack. Lastly, if an address of the subsequent instruction is identical to the target pointer stored in the return target stack, then the current instruction is a return instruction.

The present invention is directed to a method for predicting a target pointer, comprising providing a return target stack and a return instruction address table at initial, and providing a current instruction; if the current instruction is a call instruction, then the adding the address of the current instruction with the length of the current instruction to obtain a target pointer to store to eh return target stack. Then, if the address of a subsequent instruction to be fetched after the target instruction is executed is identification the target pointer of the stored in the return target stack, the current instruction is identified as a return instruction. The address of the return instruction is stored in the return instruction address table, and the target pointer identical to the subsequent instruction is deleted from the return target stack. Lastly, if the address of the current instruction is stored to the return instruction address table, the address on the top layer of the return target stack is assigned as the address of the next instruction.

According to one embodiment of the present invention, since only a content address of the program counter is needed to return to the target buffer for predicting the target pointer of the return instruction, the prediction result is thus provided in the fetch stage of a pipeline. On the other hand, since every time an instruction is called in the embodiment, a correct return address is pre-stored in the return target stack for prediction purpose, thus when a complicated program is executed, e.g. multiple program sections share a common subroutine, the prediction is still performed correctly.

### BRIEF DESCRIPTION OF DRAWINGS

FIG. 1 is an exemplary infinite loop program section.

FIG. 2 is a block diagram illustrating the structure according to one embodiment of the present invention.

FIG. 3 is a schematic flowchart illustrating method steps for judging a return instruction.

FIG. 4 is a schematic flowchart illustrating method steps for predicting a target pointer according to one embodiment of the present invention.

FIG. 5 is a schematic diagram depicting a return instruction address table according to one embodiment of the present invention.

FIG. 6 is a schematic diagram depicting a return target stack according to one embodiment of the present invention.

FIG. 7A to 7F are schematic diagrams illustrating steps of executing program section in FIG. 1 according to one embodiment of the present invention.

### DETAILED DESCRIPTION

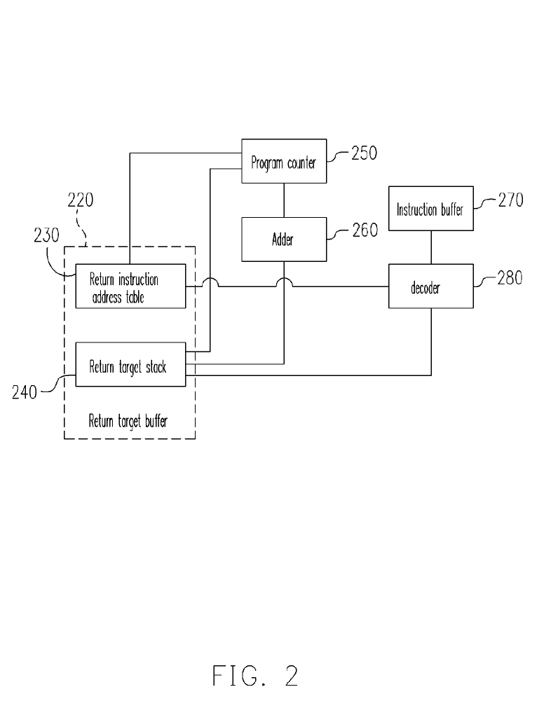

Referring to FIG. 2, it illustrates a program structure for predicting a target pointer of a return instruction according to one embodiment of the present invention. The structure comprises a return target buffer 220 serving to predict the target pointer of the return instruction, wherein the return target buffer 220 comprises a return instruction address table 230 and a return target stack 240. The instruction obtained at fetch stage is stored to the instruction buffer 270, and is identified at decode stage by the decoder 280, and wherefrom return target pointer is extracted.

Referring to FIG. 3, the method and apparatus for identifying return instruction is described herein, i.e. building a return instruction address table. The method steps according to one embodiment of the present invention comprise starting with step 302 START, fetching current instruction in step 320, and identifying if the current instruction is a call instruction. If it is, proceeding to step 302, otherwise proceeding to step 308. If it is a call instruction, the address of the current instruction is added with the length of the current instruction for obtaining a return target pointer to store in the return target stack in step 306. Then an address of a subsequent instruction is checked if it is stored in the return target stack after the current instruction is executed in step 308. If it is, proceeding to step 310 and checking whether the current instruction is a return instruction. Storing the address of the current return instruction to the return instruction address table in step 312. In step 314, the target pointer identical to the subsequent instruction is deleted from the return target stack in step 314, and proceeding to the END step 316. If the checking step in step 308 goes to negative, then directly proceeding to step 316 to END.

Referring to FIG. 4, it illustrates a flowchart of a method and an apparatus thereof for predicting return instruction target pointer, i.e. how to predict by using a return instruction address table. FIG. 4 is an extension of FIG. 3. According to an embodiment of the present invention, the method and apparatus thereof for predicting return instruction target pointer is identical to FIG. 3 before step 402, i.e. the method and apparatus for predicting return instruction target pointer is identical. Step 316 is concatenated to step 402 and 404 in FIG. 4, where an address of the current instruction is checked to be stored in the return instruction address table in step 420 after step 316 is performed. If yes, an address on topmost layer of the return target layer is assigned as the address of the next instruction in step 404, i.e. the address on topmost layer of the return target stack is predicted as the target pointer of the return instruction. The extracted return instruction target pointer is the address to fetch next instruction as passed to the program counter 250.

According to the above descriptions, the step for predicting target pointer merely comprises providing a content address of the program counter 250, that is, prediction can be done at fetch stage of the pipeline, which reduces idling stages, and improves performance of the microprocessor and digital signal processor.

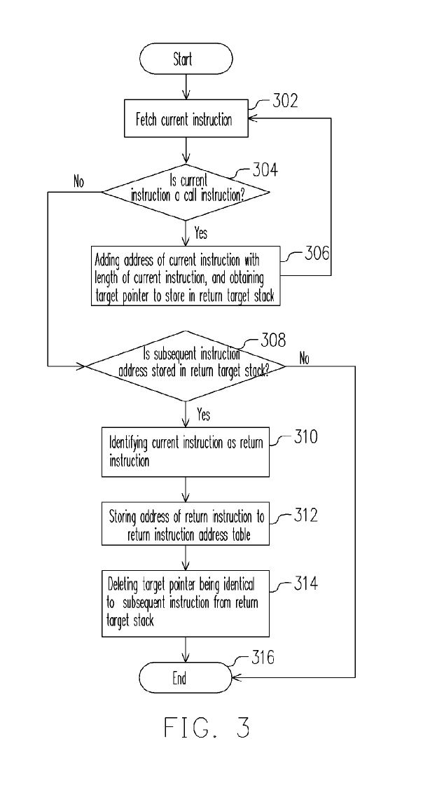

Referring to FIG. 5, it illustrates a schematic diagram of a detailed return instruction address table 230. According to one embodiment of the present invention, the return instruction address 230 comprises merely four rows, yet an arbitrary number of rows is within the scope of the present invention. Wherein each row comprises an effective flag 510 and an address column 520. All effective flags 510 are declared at initialization, indicting that no addresses are included in the return instruction address table 230. If an address is to be added, it is to be stored in the address column 520 of one of the rows, and setting the effective flag 510 of the row. Since the capacity of return instruction address table 230 is limited, if the table is fully loaded and a new address is to be added, one of the old address stored therein needs to be replaced. For those skilled in the art, it is simple to store a new address to the return instruction address table 230 to replace an old address, e.g. a circular replacing method for replacing the oldest address in the return instruction address table 230 with a new one.

Referring to FIG. 5, it also comprises how to check whether the return instruction address table includes the address of the current instruction. In FIG. 5, each of the rows corresponds to a comparator 530, which simultaneous compare all content address 550 from program counter. Then the comparing outcome of each row is passed to an OR gate 540 for a total OR operation, and the output of the OR gate 540 is the checking result 560.

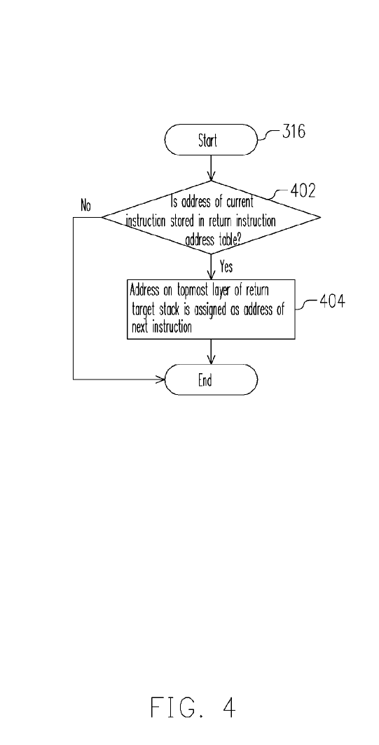

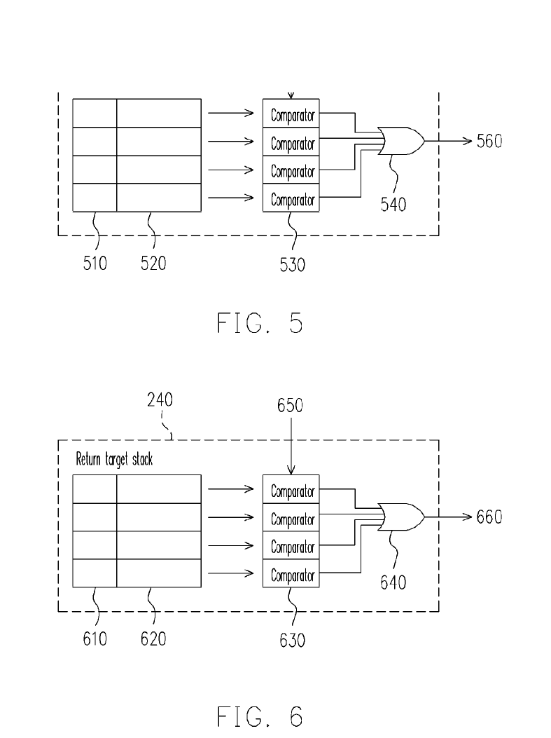

Referring to FIG. 6, it illustrates a detailed schematic diagram of the return target stack 240. The return target stack 240 comprises merely four rows according to one embodiment of the present invention, yet an arbitrary number of rows is within the scope of the present invention. Each of the rows comprises an effective flag 610 and an address column 620. All of the effective flags 610 are cleared at initialization, indicating the return target stack 240 contains no addresses. According to the embodiment of the present invention, each row of the stack 240 except the bottom row is shifted down for each time a new address is added, including the effective flag 610 and the address column 620 of each of the rows. The bottom row is overwritten with by the content of the second last row. A new address is thus written to the topmost row of the address column 620, and its corresponding flag 610 is thus set.

According to one embodiment of the present invention, the address extracted from the stack 240 is always from the address column 620 of the topmost row, which is an opposite operation to adding a new address. From the second row to the bottom row of the stack 240 are shifted up simultaneously, including the effective flag 610 and the address column 620 of each row. The content of the first row is overwritten by the second row, and the effective flag 610 of the bottom row is cleared.

According to another embodiment of the present invention, the return target stack 240 is circular queue, wherein when the queue is full the most historic current address is replaced with the latest address.

Referring to FIG. 6, it also illustrates how to check whether the return target stack 240 comprises a target pointer of return instruction. In FIG. 6, each row corresponds to a comparator 630 which simultaneously compare content of the address column 620 of each of the rows with the target pointer 650 of the current return instruction. Then the comparing results from each of the row are passed to an OR gate 640 for a thorough OR operation, where the output of the OR gate 640 is the final checking result 660.

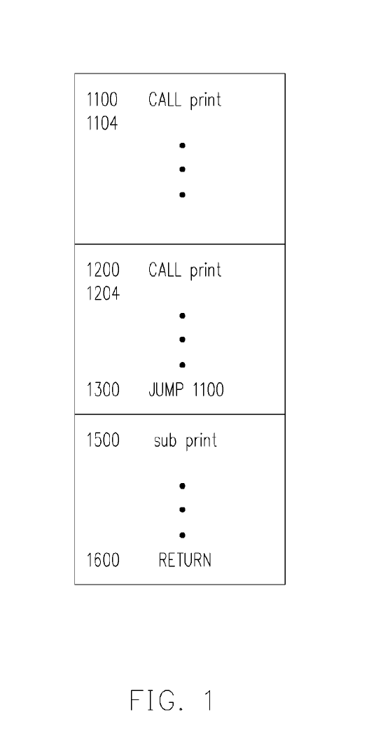

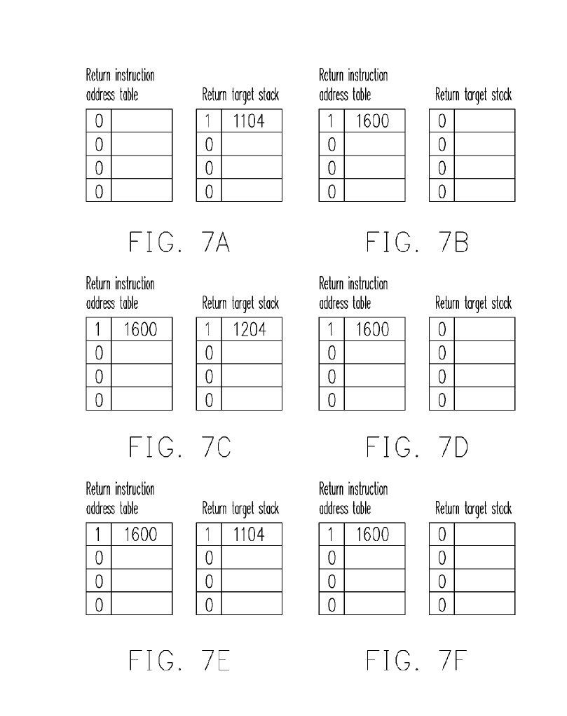

The method in the present invention is different from a conventional branch target buffer, wherein method according to the present invention precisely performs prediction a complicated condition as shown in FIG. 1. Providing the length of the call instruction is four bytes, the program is executed from address 1100. Firstly, when executing to address 1100, the content address of the current program counter is added by 4 by the first call instruction, that is 1104 is put back to the target stack as depicted in FIG. 7A. As executing to the return instruction of the address 1600, the address 1600 is added to the return instruction address table, and the target pointer 17104 is deleted from the return target stack as depicted in FIG. 7B. As executing to the call instruction of the address 1200, the address 1204 is added to the return target stack as depicted FIG. 7C. When executing the return instruction of the address 1600 for the second time, the address 1600 is already listed in the return instruction address table, thus the topmost address 1204 of the return target stack is directed fetched as the predicting result, which is a correct hit as depicted in FIG. 7D. As executing the call instruction of the address 1100 for the second time, the address 17104 is added to the return target stack as depicted in FIG. 7E. Lastly, when executing the return instruction of the address 1600 for the third time, since the address 1600 is already listed in the return instruction address table, the address 1104 on the topmost row of the return target stack is directly fetched as the predicting result, which is again a correct hit as depicted in FIG. 7F.

According to the above descriptions and embodiments, the method and structure thereof provided in the present invention is able to precisely predict target pointer of the returned instruction at the first fetch stage of a pipeline.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

What is claimed is:

1. A method for identifying return instruction, comprising: (a) providing a return target stack at initialization;
(b) fetching a current instruction;
(c) if said current instruction being a call instruction, adding an address of said current instruction with a length of said current instruction for obtaining a target pointer to store in said return target stack; and
(d) if an address of a subsequent instruction after said current instruction is executed being identical to said target pointer stored in said return target stack, said current instruction is identified as a return instruction.

2. The method as recited in claim 1, further comprising; providing a return instruction address table; and
storing an address of said return instruction to said return instruction address table.

3. The method as recited in claim 2, further comprising; deleting said target pointer identical to said subsequent instruction from said return target stack.

4. The method as recited in claim 1, further comprising; providing a plurality of rows to said return target stack;
providing an effective flag corresponding to said rows respectively; and
when said target pointer being stored to one of said rows, setting said effective flag corresponding to said row which stores said target pointer.

5. The method as recited in claim 4, further comprising; clearing said effective flag corresponding to each of said rows respectively at initialization.

6. The method as recited in claim 1, wherein said return target stack is a circular queue.

7. A method for predicting target pointer, comprising: (a) providing a return target stack and a return instruction address at initialization;
(b) fetching a current instruction;
(c) if said current instruction being a call instruction, adding an address of said current instruction with an length of said current instruction for obtaining a target pointer to store in said return target stack;
(d) if an address of a subsequent instruction after said current instruction is executed being identical to said target pointer stored in said return target stack, said current instruction is identified as a return instruction;
(e) if said current instruction is identified as a return instruction, an address of said return instruction being stored in said return instruction address table;
(f) if said current instruction is identified as a return instruction, deleting said target pointer identical to said subsequent instruction from said return target stack; and
(g) if an address of said current instruction being stored in said return instruction address table, an address on topmost layer of said return target layer is assigned as an address of a next instruction.

8. The method as recited in claim 7, further comprising; providing a plurality of rows to said return target stack;
providing an effective flag corresponding to each of said rows respectively; and
when said target pointer being stored to one of said rows, setting said effective flag corresponding to said row which stores said target pointer.

9. The method as recited in claim 8, further comprising; clearing said effective flag corresponding to each of said rows respectively at initialization.

10. The methods recited in claim 7, further comprising; providing a plurality of rows to said return instruction address table;
providing an effective flag corresponding to each of said rows respectively; and
when said target pointer being stored to one of said rows, setting said effective flags corresponding to said row which stores said target pointer.

11. The method as recited in claim 10, further comprising; clearing said effective flags corresponding to respective said rows at initialization.

12. The method as recited in claim 7, wherein said return target stack is circular queue.
